(19) United States
(12) Patent Application Publication
(10) Pub. No.: US 2014/0264024 A1
(43) Pub. Date: Sep. 18, 2014

(54) SPECIMEN INSPECTION APPARATUS

(71) Applicant: Seiko Epson Corporation, Tokyo (JP)

(72) Inventor: Hitoshi NAKAYAMA, Chino-shi (JP)

(73) Assignee: Seiko Epson Corporation, Tokyo (JP)

(21) Appl. No.: 14/205,053

(22) Filed: Mar. 11, 2014

(30) Foreign Application Priority Data
Mar. 12, 2013 (JP) 2013-048802

(51) Int. Cl. G01J 5/02; G01N 21/59

(52) U.S. Cl. CPC G01J 5/02; G01N 21/59
USPC 250/338.1

(57) ABSTRACT

A specimen inspection apparatus includes: a transportation unit which includes a transportation surface on which a specimen as an inspection object is loaded and is configured so as to transport the specimen; a terahertz wave generation unit which is positioned on the transportation surface side of the transportation unit and generates a terahertz wave; and a terahertz wave detection unit which is positioned on a side of a surface opposite the transportation surface of the transportation unit, and detects a terahertz wave which is emitted from the terahertz wave generation unit and transmits through the specimen loaded on the transportation surface, wherein the transportation unit includes a hole portion through which the transportation surface and the surface opposite the transportation surface communicate with each other, and is configured so that the specimen can be loaded on the hole portion.

### BACKGROUND

1. Technical Field

The present invention relates to a specimen inspection apparatus.

2. Related Art

In recent years, a terahertz wave which is an electromagnetic wave having a frequency of 100 GHz to 30 THz has attracted attention. The terahertz wave can be used in imaging, various measurements such as spectroscopic measurement, non-destructive testing, and the like.

For example, in Pamphlet of International Publication No. 2008/1785, a medicine (specimen) is loaded on a packing sheet which is a transportation unit for transporting the medicine, and is transported to a medicine inspection apparatus, and the medicine inspection apparatus emits a terahertz wave to the medicine on the packing sheet to detect a terahertz wave transmitting through the medicine and to inspect whether or not foreign materials are contained in the medicine.

However, in a case of detecting the terahertz wave transmitting through the specimen as in the specimen inspection apparatus disclosed in Pamphlet of International Publication No. 2008/1785, the packing sheet may absorb the terahertz wave and the terahertz wave may be attenuated. Although the packing sheet is a transparent material with respect to the terahertz wave, multiple reflections may occur in the packing sheet and detection precision may be decreased.

### SUMMARY

An advantage of some aspects of the invention is to provide a specimen inspection apparatus which can decrease an effect of a transportation unit on the terahertz wave transmitting through a specimen, when emitting a terahertz wave to a specimen loaded on the transportation unit to detect a terahertz wave transmitting through the specimen.

An aspect of the invention is directed to a specimen inspection apparatus including: a transportation unit which includes a transportation surface on which a specimen as an inspection object is loaded and is configured so as to transport the specimen; a terahertz wave generation unit which is positioned on the transportation surface side of the transportation unit and generates a terahertz wave; and a terahertz wave detection unit which is positioned on a side of a surface opposite the transportation surface of the transportation unit, and detects a terahertz wave which is emitted from the terahertz wave generation unit and transmits through the specimen loaded on the transportation surface, in which the transportation unit includes a hole portion through which the transportation surface and the surface opposite the transportation surface communicate with each other, and is configured so that the specimen can be loaded on the hole portion.

According to the specimen inspection apparatus, since the transportation unit includes the hole portion which causes the transportation surface and the surface on a side opposite the transportation surface to communicate with each other and is configured so as to transport the specimen, the terahertz wave which is emitted from the terahertz wave generation unit and transmits through the specimen is detected by the terahertz wave detection unit through the hole portion. That is, it is possible to detect the terahertz wave which transmitting through the specimen and passing through the hole portion by the terahertz wave detection unit, without being reflected by the transportation unit or causing attenuation or multiple reflections by the transportation unit. Accordingly, according to the specimen inspection apparatus, when emitting the terahertz wave to the specimen loaded on the transportation unit and detecting the terahertz wave transmitting through the specimen, it is possible to decrease an effect of the transportation unit on the terahertz wave transmitting through the specimen.

In the specimen inspection apparatus according to the aspect of the invention, the transportation surface may include a recess on which the specimen is loaded, and the hole portion may cause the recess and the surface opposite the transportation surface to communicate with each other.

According to the specimen inspection apparatus with this configuration, it is possible to limit the movement of the specimen on the transportation surface and to reliably hold the specimen on the hole portion.

In the specimen inspection apparatus according to the aspect of the invention, a width of the hole portion may be smaller than a width of the specimen.

According to the specimen inspection apparatus with this configuration, it is possible to load the specimen on the hole portion without dropping the specimen from the hole portion.

In the specimen inspection apparatus according to the aspect of the invention, the transportation unit may be configured so that one specimen can be loaded on one hole portion.

According to the specimen inspection apparatus with this configuration, it is possible to easily match the hole portion with the specimen loaded on the hole portion. Accordingly, it is possible to easily specify the specimen loaded on the transportation surface.

In the specimen inspection apparatus according to the aspect of the invention with this configuration, the transportation unit may be configured so that the plurality of specimens can be loaded on the hole portion.

According to the specimen inspection apparatus with this configuration, when emitting the terahertz wave to the specimen loaded on the transportation unit and detecting the terahertz wave transmitting through the specimen, it is possible to decrease an effect of the transportation unit on the terahertz wave transmitting through the specimen.

In the specimen inspection apparatus according to the aspect of the invention, the terahertz wave generation unit may include an optical pulse generation unit which generates an optical pulse, and a photoconductive antenna which is irradiated with the optical pulse generated by the optical pulse generation unit.

According to the specimen inspection apparatus with this configuration, when emitting the terahertz wave to the specimen loaded on the transportation unit and detecting the terahertz wave transmitting through the specimen, it is possible to decrease an effect of the transportation unit on the terahertz wave transmitting through the specimen.

The specimen inspection apparatus according to the aspect of the invention may further include a gas ejection unit which ejects gas towards the specimen loaded on the transportation surface through the hole portion to separate the specimen from the transportation surface.

According to the specimen inspection apparatus with this configuration, it is possible to easily select the specimen containing foreign materials.

In the specimen inspection apparatus according to the aspect of the invention, the hole portion may be provided in a region in which the terahertz wave transmitting through the specimen of the transportation unit passing through, and the terahertz wave detection unit may detect the terahertz wave passing through the hole portion.

According to the specimen inspection apparatus with this configuration, when emitting the terahertz wave to the specimen loaded on the transportation unit and detecting the terahertz wave transmitting through the specimen, it is possible to decrease an effect of the transportation unit on the terahertz wave transmitting through the specimen.

### BRIEF DESCRIPTION OF THE DRAWINGS

The invention will be described with reference to the accompanying drawings, wherein like numbers reference like elements.

FIG. 1 is a diagram schematically showing a configuration of a specimen inspection apparatus according to a first embodiment.

FIG. 2 is a diagram schematically showing a part of a configuration of a specimen inspection apparatus according to a first embodiment.

FIG. 3 is a schematic diagram when seen a transportation unit in a normal direction of a transportation surface.

FIG. 4 is a diagram schematically showing a configuration of a light source of a terahertz wave generation unit.

FIG. 5 is a diagram schematically showing a configuration of a filter and a detection unit of a terahertz wave detection unit.

FIG. 6 is a graph showing spectra of a medicine in a terahertz band.

FIG. 7 is a diagram showing an example of an image showing distribution of a material A, a material B, and a material C of a medicine.

FIG. 8 is a diagram schematically showing a configuration of a transportation unit according to a first modification example.

FIG. 9 is a diagram schematically showing a configuration of a transportation unit according to a second modification example.

FIG. 10 is a plan view schematically showing a configuration of a transportation unit according to a second modification example.

FIG. 11 is a plan view schematically showing a configuration of a transportation unit according to a third modification example.

FIG. 12 is a plan view schematically showing a configuration of a transportation unit according to a third modification example.

FIG. 13 is a diagram schematically showing a configuration of a terahertz wave detection unit according to a fourth modification example.

FIG. 14 is a diagram schematically showing a configuration of a specimen inspection apparatus according to a second embodiment.

FIG. 15 is a diagram schematically showing a part of a configuration of a specimen inspection apparatus according to a second embodiment.

FIG. 16 is a diagram schematically showing a configuration of a rod-like member driving unit according to a modification example of a second embodiment.

### DESCRIPTION OF EXEMPLARY EMBODIMENTS

Hereinafter, preferred embodiments of the invention will be described in detail with reference to the drawings. The embodiments which will be described hereinafter do not unduly limit the content of the invention of the aspects. All configurations which will be described hereinafter are not limited to be compulsory constituent elements of the invention.

### 1. First Embodiment

### 1.1. Configuration of Specimen Inspection Apparatus

First, a specimen inspection apparatus according to a first embodiment will be described with reference to the drawings. FIG. 1 is a diagram schematically showing a configuration of a specimen inspection apparatus 100 according to a first embodiment. FIG. 2 is a diagram schematically showing a part of a configuration of the specimen inspection apparatus 100 according to the first embodiment.

Hereinafter, the specimen inspection apparatus 100 for inspecting a medicine (pill) 2 as a specimen which is an inspection object will be described.

Herein, the inspection of the medicine 2 is investigating whether or not foreign materials (heterogeneous elements or molecules) are contained in the medicine 2. In the specimen inspection apparatus 100, the extracted specimens (medicines 2) may be lined up to be continuously inspected, or the specimen inspection apparatus 100 may be set in a medicine manufacturing line, for example, to inspect all specimens (medicines 2).

As shown in FIGS. 1 and 2, the specimen inspection apparatus 100 includes a transportation unit 10, a terahertz wave generation unit 20, and a terahertz wave detection unit 30. The specimen inspection apparatus 100 can further include a processing unit (CPU) 40, a manipulation unit 50, a display unit 52, and a storage unit 54.

The transportation unit 10 includes a transportation surface 10a on which the medicine 2 is loaded, and is configured so as to transport the medicine 2. In the example shown in the drawing, the transportation unit 10 includes the transportation surface 10a and a surface (rear surface) 10b on a side opposite the transportation surface 10a. The transportation surface 10a is a surface in which the in-plane direction is a transportation direction X of the medicines 2, in a state where the medicines 2 are transported. In this case, a normal direction P of the transportation surface 10a is a direction perpendicular to the transportation direction X of the medicines 2. The transportation surface 10a is, for example, a flat surface.

The transportation unit 10 includes a hole portion 12 which causes the transportation surface 10a and the rear surface 10b to communicate with each other. That is, one opening of the hole portion 12 is provided on the transportation surface 10a and the other opening of the hole portion 12 is provided on the rear surface 10b. In the example shown in the drawing, the hole portion 12 penetrates the transportation unit 10 in the normal direction P of the transportation surface 10a. The hole portion 12 is provided on a region through which the terahertz wave transmitting through the medicine 2 of the transportation unit 10 passes. As shown in FIG. 1, the plurality of hole portions 12 are provided and an interval between the hole portions 12 adjacent to each other is constant.

The transportation unit 10 is configured to load the medicine 2 on the hole portion 12. As shown in FIG. 2, for example, by setting a width W₁₂ of the hole portion 12 to be smaller than a width W₂ of the medicine 2, the medicine 2 can be loaded on the hole portion 12. In the example shown in the drawing, one medicine 2 is loaded on one hole portion 12.

FIG. 3 is a schematic diagram when seen the transportation unit 10 in the normal direction P of the transportation surface 10a. A shape of the hole portion 12 is, for example, a circle when seen from the normal direction P as shown in FIG. 3. Herein, in a case where a shape of the medicine 2 is a circle when seen from the normal direction P, the width W₂ of the medicine 2 is a diameter of the medicine 2. In this case, the shape of the hole portion 12 is a circle when seen from the normal direction P as shown in FIG. 3, for example, and the width W₁₂ of the hole portion 12 is a diameter of the hole portion 12. The shape of the hole portion 12 is not particularly limited as long as the medicine 2 can be loaded on the hole portion 12.

In the example shown in the drawing, the transportation unit 10 is a belt. The transportation unit 10 is laid across belt wheels 14a and 14b. The transportation unit 10 can be circulated by rotation of the belt wheels 14a and 14b, to transport the medicine 2 loaded on the transportation surface 10a. In the example shown in FIG. 1, the transportation surface 10a is a surface between a position P1 to which the medicine 2 is supplied from the supply unit 60 and a position P2 from which the medicine 2 is collected from the transportation unit 10, and is a surface facing outside of a loop formed by the transportation unit (belt) 10. That is, the transportation surface 10a is an upper surface of the transportation unit 10 between the position P1 and the position P2. The rear surface 10b is a surface between the position P1 to which the medicine 2 is supplied from the supply unit 60 and the position P2 from which the medicine 2 is collected from the transportation unit 10, and is a surface facing inside of a loop formed by the transportation unit (belt) 10. That is, the rear surface 10b is a lower surface of the transportation unit 10 between the position P1 and the position P2.

A material of the transportation unit 10 is rubber, a resin, metal, paper, or cloth, for example. The material of the transportation unit 10 is not particularly limited. As the material of the transportation unit 10, a material which allow the terahertz wave to transmit therethrough may be used, or a material which does not allow the terahertz wave to transmit therethrough may be used.

As shown in FIG. 2, since the transportation unit 10 is configured so that the medicine 2 can be loaded on the hole portion 12, the terahertz wave which is emitted from the terahertz wave generation unit 20 and transmits through the medicine 2 passes through the hole portion 12 to be detected by the terahertz wave detection unit 30. That is, the terahertz wave transmitting through the medicine 2 and passing through the hole portion 12 can be detected by the terahertz wave detection unit 30, without being reflected by the transportation unit 10 or causing attenuation or multiple reflections by the transportation unit 10. Accordingly, it is possible to decrease an effect of the transportation unit 10 on the terahertz wave transmitting through the medicine 2.

Herein, when seen from the irradiation direction of the terahertz wave emitted from the terahertz wave generation unit 20, a region 2a which is overlapped with the hole portion 12 of the medicine 2, is a region in which the terahertz wave transmitting through the medicine 2 is detected without the effect of the transportation unit 10. Accordingly, when it is desired to have a large region in which the terahertz wave transmitting through the medicine 2 can be detected without the effect of the transportation unit 10, that is, when it is desired to have a large region 2a of the medicine 2, it is preferable to set a size of the hole portion 12 when seen from the irradiation direction of the terahertz wave to be large. Therefore, for example, in the example shown in FIG. 2, the width W₁₂ of the hole portion 12 is desirable to be large in a range of being smaller than the width W₂ of the medicine 2.

The transportation unit 10 can transport the medicine 2 from the position P1 to which the medicine 2 is supplied from the supply unit 60 to the position P2 from which the medicine 2 is collected from the transportation unit 10. While the transportation unit 10 transports the medicine 2 from the position P1 to the position P2, the terahertz wave generation unit 20 and the terahertz wave detection unit 30 perform measurement of the medicine 2.

The supply unit 60 supplies the medicines 2 to the transportation unit 10. The supply unit 60 supplies the medicines 2 one by one to an upper portion of the hole portion 12. When the hole portion 12 reaches the position P1, the supply unit 60 drops the medicine 2 and loads the medicine 2 on the hole portion 12.

The terahertz wave generation unit 20 is positioned on the transportation surface 10a of the transportation unit 10. The terahertz wave generation unit 20 generates the terahertz wave. The “terahertz wave” is an electromagnetic wave having a frequency of 100 GHz to 30 THz, particularly an electromagnetic wave having a frequency of 300 GHz to 10 THz. As shown in FIG. 2, the terahertz wave generation unit 20 includes a light source 22.

A plurality of light sources 22 are provided. In addition, a single light source 22 may be provided. FIG. 4 is a diagram schematically showing a configuration of the light source 22 of the terahertz wave generation unit 20. As shown in FIG. 4, the light source 22 includes an optical pulse generation unit 23 and a photoconductive antenna 24.

The optical pulse generation unit 23 generates an optical pulse which is an excitation light. Herein, the optical pulse is light in which intensity sharply changes in a short time. A pulse width (full-width at half-maximum FWHM) of the optical pulse is, for example, equal to or more than 1 fs (femtosecond) and equal to or less than 800 fs.

As the optical pulse generation unit 23, a semiconductor laser including a pulse compression unit formed of a semiconductor material, a femtosecond fiber laser, or a titanium-sapphire laser is used, for example. Particularly, the semiconductor laser can be miniaturized and therefore can be preferably used as the optical pulse generation unit 23.

The photoconductive antenna 24 is irradiated with the optical pulse generated by the optical pulse generation unit 23 and accordingly generates the terahertz wave. In the example shown in the drawing, the photoconductive antenna 24 is a dipole-shaped photoconductive antenna (PCA). The photoconductive antenna 24 includes a substrate 25 which is a semiconductor substrate, and a pair of electrodes 27 which are provided on the substrate 25 and are disposed to face each other with a gap 26 interposed therebetween. When the optical pulse is emitted between the electrodes 27, the photoconductive antenna 24 generates the terahertz wave.

The substrate 25 includes, for example, a semi-insulating GaAs (SI-GaAs) substrate and a low temperature growth GaAs (LT-GaAs) layer which is provided on the SI-GaAs substrate. A material of the electrodes 27 is gold, for example. A distance between the pair of electrodes 27 is not particularly limited and is suitably set according to conditions, but is equal to or greater than 1 μm or equal to or smaller than 10 μm.

Herein, an operating principle of the light source 22 will be described. In the light source 22, first, the optical pulse generation unit 23 generates the optical pulse and emits the optical pulse towards the gap 26 of the photoconductive antenna 24. By emitting the optical pulse to the gap 26, free electrons are excited in the photoconductive antenna 24. Then, movement of the free electrons is accelerated by applying a voltage between the electrodes 27. Accordingly, the terahertz wave is generated.

The light source 22 is not limited to have a configuration of including the optical pulse generation unit 23 and the photoconductive antenna 24 shown in FIG. 4, and a quantum cascade laser, a difference frequency generation system or a parametric system using a non-linear optical crystal may be used, as the optical light 22, for example.

As shown in FIG. 2, the terahertz wave generation unit 20 may include a lens 28 for collimating the terahertz wave emitted from the light source 22 to introduce the terahertz wave to the medicine 2. Accordingly, it is possible to efficiently introduce the terahertz wave emitted from the light source 22 to the medicine 2. The lens 28 may be a lens which concentrate (focus) the terahertz wave to introduce the terahertz wave to the medicine 2.

As shown in FIG. 2, the terahertz wave generation unit 20 emits the terahertz wave emitted from the light source 22 to the normal direction P of the transportation surface 10a through the lens 28. Accordingly, the terahertz wave is emitted to the medicine 2. That is, the irradiation direction of the terahertz wave is the normal direction P of the transportation surface 10a. The terahertz wave which is emitted to the medicine 2 and transmits through the medicine 2, passes through the hole portion 12 of the transportation unit 10 to be detected by the terahertz wave detection unit 30.

The terahertz wave detection unit 30 is positioned on the rear surface 10b of the transportation unit 10. That is, the terahertz wave detection unit 30 is positioned on a side opposite the terahertz wave generation unit 20 with respect to the transportation unit 10. In the example shown in FIG. 1, the terahertz wave detection unit 30 is positioned on the inside of the loop formed by the transportation unit (belt) 10, and the terahertz wave generation unit 20 is positioned on the outside of the loop formed by the transportation unit (belt) 10.

As shown in FIG. 2, the terahertz wave detection unit detects the terahertz wave which is emitted from the terahertz wave generation unit 20 and transmits through the medicine 2 loaded on the transportation surface 10a. The terahertz wave detection unit 30 includes a filter 32 and a detection unit 34.

The filter 32 allows the terahertz wave having a target wavelength to transmit therethrough. A material of the filter 32 is metal, for example. FIG. 5 is a diagram schematically showing the filter 32 and the detection unit 34 of the terahertz wave detection unit 30.

As shown in FIG. 5, the filter 32 includes a plurality of pixels (unit filter unit) 32a disposed two-dimensionally. The plurality of pixels 32a are disposed in a matrix. Each of the pixels 32a includes a plurality of regions for passing through the terahertz waves having different wavelengths from each other, that is, a plurality of regions in which the wavelengths of the terahertz waves passing through (hereinafter, also referred to as “pass wavelengths”) are different from each other. In the example shown in the drawing, each of the pixels 32a includes a first region 321, a second region 322, a third region 323, and a fourth region 324.

As the detection unit 34, a unit which detects the terahertz wave by converting the terahertz wave into heat, that is, a unit which can detect energy (intensity) of the terahertz wave by converting the terahertz wave into heat is used, for example. In detail, the detection unit 34 is a pyroelectric sensor or a bolometer.

The detection unit 34 detects the terahertz wave having a target wavelength transmitting through the filter 32. The detection unit 34 includes a first unit detection unit 341, a second unit detection unit 342, a third unit detection unit 343, and a fourth unit detection unit 344 provided corresponding to the first region 321, the second region 322, the third region 323, and the fourth region 324 of the pixel 32a, respectively. The first unit detection unit 341, the second unit detection unit 342, the third unit detection unit 343, and the fourth unit detection unit 344 detect the terahertz wave passing through the first region 321, the second region 322, the third region 323, and the fourth region 324 of the pixel 32a, respectively, by converting the terahertz wave into heat. Accordingly, in each of the pixels 32a, it is possible to reliably detect terahertz waves having four target wavelengths.

As shown in FIG. 2, the terahertz wave detection unit 30 may include a lens 36 for concentrating the terahertz wave transmitting through the medicine 2 to be introduced to the filter 32. Accordingly, it is possible to efficiently introduce the terahertz wave transmitting through the medicine 2 to the filter 32.

As shown in FIG. 2, the light source 22, the lens 28, the lens 36, the filter 32, and the detection unit 34 are disposed to be lined in the normal direction P of the transportation surface 10a.

As shown in FIG. 1, the manipulation unit 50 acquires a manipulation signal based on manipulation by a user and performs a process for transmitting the manipulation signal to the processing unit 40. The manipulation unit 50 is a touch panel-type display, button, keys, or a microphone, for example.

The display unit 52 displays processed results of the processing unit 40 as characters, graphs, or other information, based on a display signal input from the processing unit 40. For example, the display unit 52 displays an image (image showing distribution of materials of the medicine 2, see FIG. 7) created by an image generation unit 42. The display unit 52 is, for example, a cathode ray tube (CRT), a liquid crystal display (LCD), or a touch panel-type display. The functions of the manipulation unit 50 and the display unit 52 may be realized by a one touch panel-type display.

The storage unit 54 stores a program or data for performing various calculation processes or control processes by the processing unit 40. The storage unit 54 is used as a working area of the processing unit 40, and is also used to temporarily store the manipulation signal input from the manipulation unit 50, the data (detected results) acquired from the terahertz wave detection unit 30, and a result of an operation executed according to various programs by the processing unit 40.

The processing unit (CPU) 40 performs various calculation processes based on data acquired from the terahertz wave detection unit 30 or various control processes, based on a program stored in the storage unit 54. In detail, by executing the program stored in the storage unit 54, the processing unit 40 functions as the image generation unit 42.

### 1.2. Medicine Inspection Process

Next, a flow of a process of a medicine (specimen) in the specimen inspection apparatus 100 will be described with reference to the drawings.

As shown in FIG. 1, the supply unit 60 supplies the medicine 2 onto the transportation surface 10a of the circulating transportation unit 10. The medicine 2 is loaded on the hole portion 12 positioned on the position P1 and is transported by the transportation unit 10.

As shown in FIG. 2, when the medicine 2 is transported between the terahertz wave generation unit 20 and the terahertz wave detection unit 30, the terahertz wave generated by the terahertz wave generation unit 20 is emitted to the medicine 2.

The terahertz wave emitted to the medicine 2 transmits through the medicine 2, passes through the hole portion 12, and is emitted to the terahertz wave detection unit 30. The terahertz wave detection unit 30 transmits a signal S30 based on the detected result to the processing unit 40 (image generation unit 42). The image generation unit 42 generates an image showing the distribution of the materials of the medicine 2, based on the detected results of the terahertz wave detection unit 30.

Hereinafter, a case where the medicine 2 is configured with three materials A, B, and C (materials B and C are foreign materials) will be described in detail. FIG. 6 is a graph showing spectra of the medicine 2 in a terahertz band.

The first region 321 and the second region 322 are used in the pixel 32a of the filter 32 of the terahertz wave detection unit 30 shown in FIG. 5. When a pass wavelength of the first region 321 is set to λ1, a pass wavelength of the second region 322 is set to λ2, intensity of the component at the wavelength λ1 of the terahertz wave transmitting through the medicine 2 is set to α1, and intensity of the component at the wavelength λ2 thereof is set to α2, the pass wavelength λ1 of the first region 321 and the pass wavelength λ2 of the second region 322 are set so that differences (α2−α1) between the intensity α2 and the intensity α1 can be significantly differentiated between the material A, the material B, and the material C.

As shown in FIG. 6, in the material A, the difference (α2−α1) between the intensity α2 of the component at the wavelength λ2 and the intensity α1 of the component at the wavelength λ1 of the terahertz wave transmitting through the medicine 2 is a positive value. In the material B, the difference (α2−α1) between the intensity α2 and the intensity α1 is zero. In the material C, the difference (α2−α1) between the intensity α2 and the intensity α1 is a negative value.

The terahertz wave detection unit 30 detects the intensity α1 and the intensity α2. The terahertz wave detection unit 30 transmits the signal S30 (see FIG. 1) including information of the detected result, to the processing unit 40 (image generation unit 42). The emission of the terahertz wave to the medicine 2 and the detection of the terahertz wave transmitting through the medicine 2 are performed with respect to the region 2a of the medicine 2 which is positioned on the hole portion 12 (that is, superimposed with the hole portion 12 when seen from the irradiation direction of the terahertz wave).

The image generation unit 42 acquires the difference (α2−α1) between the intensity α2 and the intensity α1 based on the detected results of the terahertz wave detection unit 30. From the medicine 2, a portion in which the difference (α2−α1) is a positive value, a portion in which the difference (α2−α1) is zero, and a portion in which the difference (α2−α1) is a negative value are specified as the material A, the material B, and the material C, respectively. The image generation unit 42 generates an image showing the distribution of the materials A, B, and C of the medicine 2, based on the specified result.

FIG. 7 is an example of the image showing the distribution of the materials A, B, and C of the medicine 2 (region 2a), generated by the image generation unit 42. For example, the image is displayed by coloring a region with the distribution of the material A of the medicine 2 in black, a region with the distribution of the material B in gray, and a region with the distribution of the material C in white.

As shown in FIG. 7, the processing unit 40 displays the image showing the distribution of the materials A, B, and C of the medicine 2 which is generated by the image generation unit 42, on the display unit 52. As described above, in the specimen inspection apparatus 100, it is possible to image and display the distribution of the materials configuring the medicine 2.

In the above description, the example in which the materials are specified from the signs of the difference between the intensity α2 and the intensity α1, is shown, but it is not limited to this method. For example, the materials may be specified using values of the difference between the intensity α2 and the intensity α1. In this case, the materials can be specified by comparing the values of the difference between the intensity α2 and the intensity α1 with spectra of each material.

The medicine 2 measured by the terahertz wave generation unit 20 and the terahertz wave detection unit 30 is transported to the position P2 shown in FIG. 1 by the transportation unit 10 to be collected.

The specimen inspection apparatus 100 can repeatedly perform the processes described above with respect to each of the medicines 2 sequentially supplied from the supply unit 60, and image and display the distribution of the materials configuring the medicine 2, for each medicine sequentially supplied.

The specimen inspection apparatus 100, for example, has the following characteristics.

In the specimen inspection apparatus 100, the transportation unit 10 includes the hole portion 12 which causes the transportation surface 10a and the surface 10b on a side opposite the transportation surface 10a, to communicate with each other, and is configured so that the medicine 2 can be loaded on the hole portion 12. Accordingly, the terahertz wave which is emitted from the terahertz wave generation unit 20 and transmits through the medicine 2 passes through the hole portion 12 and is detected by the terahertz wave detection unit 30. That is, the terahertz wave which transmits through the medicine 2 and passes through the hole portion 12 can be detected by the terahertz wave detection unit 30, without being reflected by the transportation unit 10 or causing attenuation or multiple reflections by the transportation unit 10. Thus, according to the specimen inspection apparatus 100, when emitting the terahertz wave to the medicine 2 loaded on the transportation unit 10 to detect the terahertz wave transmitting through the medicine 2, it is possible to decrease the effect of the transportation unit 10 on the terahertz wave transmitting through the medicine 2.

In the specimen inspection apparatus 100, since the width W₁₂ of the hole portion 12 is smaller than the width W₂ of the medicine 2, it is possible to load the medicine 2 on the hole portion 12 without dropping the medicine 2 from the hole portion 12.

In the specimen inspection apparatus 100, since the transportation unit 10 is configured so that one medicine 2 can be loaded on the hole portion 12, it is possible to easily match the hole portion 12 with the medicine 2 loaded on the hole portion 12. For example, in a case where it is configured so that one medicine 2 can be loaded on one hole portion 12, by marking each hole portion 12 on the transportation surface 10a for specifying the hole portions 12, it is possible to easily match the hole portion 12 with the medicine 2 loaded on the hole portion 12. Accordingly, it is possible to easily specify the predetermined medicine 2 from the plurality of medicines 2 loaded on the transportation surface 10a. Thus, when collecting the medicines 2 from the transportation unit 10, for example, the medicine 2 containing foreign materials and the medicine 2 not containing foreign materials are easily selected.

### 1.3. Modification Example

Next, modification examples of the specimen inspection apparatus according to the first embodiment will be described. In each modification example described below, the same reference numerals are denoted for the members having the same function as the specimen inspection apparatus 100 described above, and the specific description thereof will be omitted.

### 1. First Modification Example

First, a first modification example will be described. FIG. 8 is a diagram schematically showing a configuration of the transportation unit 10 according to the first modification example.

As shown in FIG. 2, in the specimen inspection apparatus 100, the transportation surface 10a of the transportation unit 10 is a flat surface.

Meanwhile, in this modification example, the transportation surface 10a of the transportation unit 10 includes a recess 16 on which the medicine 2 is loaded, and the hole portion 12 causes the recess 16 and the rear surface 10b to communicate with each other.

The transportation surface 10a includes the recess 16. In the example shown in the drawing, the transportation surface 10a includes a first region 11a and a second region 11b which have different distances to the rear surface 10b from each other, and a third region 11c which connects the first region 11a and the second region 11b to each other. In the example shown in the drawing, a distance h1 from the first region 11a to the rear surface 10b is longer than a distance h2 from the second region 11b to the rear surface 10b. The recess 16 is configured with the second region 11b and the third region 11c. A depth (height of level difference h1−h2) of the recess 16 of the transportation surface 10a is appropriately set according to the size of the medicine 2. The difference in level is provided on the transportation surface 10a by the first region 11a and the second region 11b. As the medicine 2 is loaded on the recess 16 (second region 11b) the difference in level provided on the transportation surface 10a can limit the movement of the medicine 2 on the transportation surface 10a.

The hole portion 12 causes the recess 16 and the rear surface 10b to communicate with each other. In the example shown in the drawing, the hole portion 12 causes the second region 11b and the rear surface 10b of the transportation surface 10a to communicate with each other. That is, one opening of the hole portion 12 is provided on the recess 16 (second region 11b) and the other opening of the hole portion 12 is provided on the rear surface 10b.

A width (diameter) W₁₆ of the recess 16 is larger than the width (diameter) W₂ of the medicine 2 and the width (diameter) W₁₂ of the hole portion 12. A shape of the recess 16 is, for example, a circle when seen from the normal direction P of the transportation surface 10a. The shape or the size of the recess 16 is not particularly limited as long as it limits the movement of the medicine 2 on the transportation surface 10a and holds the medicine 2 on the hole portion 12.

According to this modification example, the transportation surface 10a of the transportation unit 10 includes the recess 16 on which the medicine 2 is loaded, and the hole portion 12 causes the recess 16 and the rear surface 10b to communicate with each other, and therefore it is possible to limit the movement of the medicine 2 on the transportation surface 10a and reliably hold the medicine 2 on the hole portion 12. The recess 16 can be set as a part of the hole portion 12. That is, the hole portion 12 connected to the transportation surface 10a may have the width W₁₆ which is larger than the width W₂ of the medicine 2 to configure the recess.

### 2. Second Modification Example

Next, a second modification example will be described. FIG. 9 is a diagram schematically showing a configuration of the transportation unit 10 according to the second modification example. FIG. 10 is a plan view schematically showing a configuration of the transportation unit 10 according to the second modification example. FIG. 10 is a diagram when the transportation unit 10 is seen from the normal direction P of the transportation surface 10a.

As shown in FIGS. 2 and 3, the transportation unit 10 of the specimen inspection apparatus 100 is configured so that one medicine 2 can be loaded on one hole portion 12.

Meanwhile, as shown in FIGS. 9 and 10, the transportation unit 10 according to this modification example is configured so that the plurality of medicines 2 can be loaded on one hole portion 12. In the example shown in the drawing, it is configured so that three medicines 2 can be loaded on one hole portion 12, but the number thereof is not limited thereto.

The shape of the hole portion 12 is a rectangle having long sides parallel to the transportation direction X when seen from the normal direction P of the transportation surface 10a as shown in FIG. 10. That is, the hole portion 12 is a slit which extends in the transportation direction X (transportation direction X is a longitudinal direction). Accordingly, in the transportation unit 10, the plurality of medicines 2 can be lined along the transportation direction X on the hole portion 12.

In the example shown in the drawing, a size (width W₁₂ of the hole portion 12) of a short side of the hole portion 12 is smaller than the width W₂ of the medicine 2. Accordingly, the transportation unit 10 can load the medicines 2 on the hole portion 12.

### 3. Third Modification Example

Next, a third modification example will be described. FIG. 11 is a plan view schematically showing a configuration of the transportation unit 10 according to the third modification example. FIG. 11 is a diagram when the transportation unit 10 is seen from the normal direction P of the transportation surface 10a.

As shown in FIG. 3, one hole portion 12 is provided in a width direction of the transportation unit 10 in the transportation unit 10 of the specimen inspection apparatus 100. That is, the transportation unit 10 is configured so as to transport the medicines 2 by lining the medicines in a line.

Meanwhile, in this modification example, as shown in FIG. 11, in the transportation unit 10, the plurality of (two) hole portions 12 are provided in the width direction (direction perpendicular to the transportation direction X when seen from the normal direction P of the transportation surface 10a) Y of the transportation unit 10. That is, the transportation unit 10 is configured so as to transport the medicines 2 by lining the medicines in a plurality of lines (two lines).

As shown in FIG. 12, the transportation unit 10 may include the hole portion 12 which extends in the width direction Y of the transportation unit 10, and may be configured so that the plurality of (two) medicines 2 can be loaded on one hole portion 12 by lining in the width direction Y of the transportation unit 10. The shape of the hole portion 12 is a rectangle having long sides parallel to the width direction Y of the transportation unit 10 when seen from the normal direction P of the transportation surface 10a as shown in FIG. 12. That is, the hole portion 12 is a slit which extends in the width direction Y of the transportation unit 10 (width direction Y is a longitudinal direction).

Although not shown, the terahertz wave generation unit 20 (see FIGS. 1 and 2) emits the terahertz wave to the plurality of (two) medicines 2 which are lined in the width direction Y of the transportation unit 10. Then, the terahertz wave detection unit 30 (see FIGS. 1 and 2) detects the terahertz wave transmitting through the plurality of (two) medicines 2 which are lined in the width direction Y of the transportation unit 10 and passes through the hole portion 12. Accordingly, it is possible to inspect the plurality of (two) medicines 2 which are lined in the width direction Y of the transportation unit 10 at the same time. Thus, according to this modification example, the inspection of a large amount of the medicines 2 can be performed in a shorter time.

### 4. Fourth Modification Example

Next, a fourth modification example will be described. FIG. 13 is a diagram schematically showing a configuration of the terahertz wave detection unit 30 according to the fourth modification example.

As shown in FIG. 2, the terahertz wave detection unit 30 of the specimen inspection apparatus 100 extracts a target wavelength by causing the terahertz wave transmitting through the medicine 2 to transmit the filter 32 and detects the terahertz wave with the detection unit 34.

Meanwhile, in this modification example, as shown in FIG. 13, the terahertz wave generated by the terahertz wave generation unit 20 having a target wavelength is extracted by the filter 70 and is emitted to the medicine 2, and the terahertz wave transmitting through the medicine 2 is detected by the terahertz wave detection unit 30.

The filter 70 allows the terahertz wave having a target wavelength to transmit therethrough. A material of the filter 70 is metal, for example. In the example shown in the drawing, the filter 70 is positioned between the light sources 22 and the lens 28. In this modification example, the terahertz wave detection unit 30 does not include the filter 70 (see FIG. 2).

### 2. Second Embodiment

### 2.1. Configuration of Specimen Inspection Apparatus

Next, a specimen inspection apparatus according to a second embodiment will be described with reference to the drawings. FIG. 14 is a diagram schematically showing a configuration of a specimen inspection apparatus 200 according to the second embodiment. FIG. 15 is a diagram schematically showing a part of a configuration of the specimen inspection apparatus 200. In the specimen inspection apparatus 200 according to the second embodiment, the same reference numerals are denoted for the members having the same function as the specimen inspection apparatus 100 described above, and the specific description thereof will be omitted.

As shown in FIGS. 14 and 15, the specimen inspection apparatus 200 includes a gas ejection unit 210 which ejects gas G towards the medicine 2 loaded on the transportation surface 10a through the hole portion 12 of the transportation unit 10 and separates the medicine 2 from the transportation surface 10a.

The gas ejection unit 210 can eject the gas G with respect to the medicine 2 positioned in a position P4 of the transportation unit 10 on the downstream (transportation direction X side with respect to the position P3 in which the terahertz wave is emitted) of a position P3 in which the terahertz wave is emitted, to blow off the medicine 2 and to separate the medicine 2 from the transportation surface 10a. Accordingly, for example, it is possible to remove the medicine 2 which is determined to contain the foreign materials based on the detected results of the terahertz wave detection unit 30, from the transportation unit 10.

The specimen inspection apparatus 200 further includes a determination unit 44 and a control unit 46. In detail, the processing unit 40 functions as the determination unit 44 and the control unit 46 by executing a program stored in the storage unit 54.

The determination unit 44 performs a process of determining whether or not the medicine 2 contains the foreign materials, based on the image (see FIG. 7) showing the distribution of the materials of the medicine 2 generated by the image generation unit 42.

The control unit 46 performs a process of controlling the gas ejection unit 210 based on the determined results of the determination unit 44.

### 2.2. Medicine Inspection Process

Next, a flow of a process of medicine (specimen) in the specimen inspection apparatus 200 will be described with reference to the drawings. Points different from those of the medicine inspection process of the specimen inspection apparatus 100 will be described, and the overlapping points will be omitted.

As shown in FIG. 14, the supply unit 60 supplies the medicine 2 onto the transportation surface 10a of the circulating transportation unit 10. The medicine 2 is loaded on the hole portion 12 positioned on the position P1 and is transported by the transportation unit 10.

When the medicine 2 is transported between the terahertz wave generation unit 20 and the terahertz wave detection unit 30, the terahertz wave generated by the terahertz wave generation unit 20 is emitted to the medicine 2.

The terahertz wave emitted to the medicine 2 transmits through the medicine 2, passes through the hole portion 12, and is emitted to the terahertz wave detection unit 30. The terahertz wave detection unit 30 transmits a signal S30 based on the detected result to the processing unit 40 (image generation unit 42). The image generation unit 42 generates an image showing the distribution of the materials of the medicine 2, based on the detected results of the terahertz wave detection unit 30.

The determination unit 44 performs a process of determining whether or not the medicine 2 contains the foreign materials, based on the image (see FIG. 7) showing the distribution of the materials of the medicine 2 generated by the image generation unit 42. In detail, in a case where the material B and the material C are checked in the image shown in FIG. 7, the determination unit 44 determines that the medicine 2 contains the foreign materials. In a case where the material B and the material C are not checked in the image shown in FIG. 7, the determination unit 44 determines that the medicine 2 does not contain the foreign materials.

In a case where it is determined that the medicine 2 contains foreign materials by the determination unit 44, when the medicine 2 which is determined to contain the foreign materials reaches the position P4, the control unit 46 controls the gas ejection unit 210 to eject the gas G towards the medicine 2 to separate the medicine 2 from the transportation surface 10a. Accordingly, it is possible to remove the medicine 2 containing the foreign materials from the transportation unit 10.

On the other hand, in a case where it is determined that the medicine 2 does not contain foreign materials by the determination unit 44, the medicine 2 is transported to the position P2 by the transportation unit 10 to be collected.

The specimen inspection apparatus 200 can repeatedly perform the processes described above with respect to each of the medicines 2 sequentially supplied from the supply unit 60, can determine whether or not the foreign materials are contained with respect to each of the medicines 2, and can collect only the medicines 2 which are determined not to contain the foreign materials.

Herein, the determination unit 44 determines whether or not the medicine 2 contains the foreign materials, and the control unit 46 performs a process of controlling the gas ejection unit 210 to remove the medicine 2 which contains the foreign materials, based on the determined result of the determination unit 44, but a user may determine whether or not the medicine 2 contains the foreign materials and manipulate the gas ejection unit 210 to remove the medicine 2 which contains the foreign materials from the transportation unit 10, by looking at the image (see FIG. 7) showing the distribution of the materials of the medicine 2 generated by the image generation unit 42.

According to the specimen inspection apparatus 200, since the gas ejection unit 210 ejects the gas G towards the medicine 2 loaded on the transportation surface 10a through the hole portion 12 to separate the medicine 2 from the transportation surface 10a, it is possible to easily select the medicine 2 containing the foreign materials.

### 2.3. Modification Example

Next, a modification example of the specimen inspection apparatus according to the second embodiment will be described. FIG. 16 is a diagram schematically showing a configuration of a rod-like member driving unit 220 according to the modification example. Hereinafter, the same reference numerals are denoted for the members having the same function as the specimen inspection apparatus 200 described above, and the specific description thereof will be omitted.

As shown in FIGS. 14 and 15, in the specimen inspection apparatus 200 described above, the gas ejection unit 210 ejects the gas G towards the medicine 2 loaded on the transportation surface 10a through the hole portion 12 to separate the medicine 2 from the transportation surface 10a.

Meanwhile, as shown in FIG. 16, instead of the gas ejection unit 210, the specimen inspection apparatus 200 according to this modification example includes the rod-like member driving unit 220 which drives a rod-like member 222 to protrude with respect to the medicine 2 loaded on the transportation surface 10a through the hole portion 12 to separate the medicine 2 from the transportation surface 10a.

By protrusion of the rod-like member 222 with respect to the medicine 2 loaded on the transportation surface 10a through the hole portion 12, the rod-like member driving unit 220 can blow off the medicine 2 to be separated from the transportation surface 10a. Accordingly, for example, it is possible to remove the medicine 2 which is determined to contain the foreign materials based on the detected results of the terahertz wave detection unit 30, from the transportation unit 10.

The embodiments and the modification examples are examples and the invention is not limited thereto.

For example, in the specimen inspection apparatus according to each embodiment and each modification, the case in which the specimen as an inspection object is the medicine 2 has been described, but the specimen is not limited to the medicine. For example, the specimen may be a food item such as salt or a snack, crops such as cereal or a fruit, a beauty product such as a soap or a lipstick, an electronic material such as a semiconductor substrate or a superconductive material, or a living body such as skin or a bone.

It is also possible to appropriately combine the embodiments and the modification examples, for example.

The invention includes substantially the same configuration as the configuration described in the embodiments (for example, configuration having the same functions, methods, and results, or configuration having the same object and effects). The invention includes a configuration obtained by replacing the non-essential parts of the configuration described in the embodiments. The invention includes a configuration for realizing the same operation results or a configuration for reaching the same object as the configuration described in the embodiments. The invention includes a configuration obtained by adding the related art to the configuration described in the embodiments.

The entire disclosure of Japanese Patent Application No. 2013-048802, filed Mar. 12, 2013 is expressly incorporated by reference herein.

What is claimed is:

1. A specimen inspection apparatus comprising:
a transportation unit which includes a transportation surface on which a specimen as an inspection object is loaded and is configured so as to transport the specimen;
a terahertz wave generation unit which is positioned on the transportation surface side of the transportation unit and generates a terahertz wave; and
a terahertz wave detection unit which is positioned on a side of a surface opposite the transportation surface of the transportation unit, and detects a terahertz wave which is emitted from the terahertz wave generation unit and transmits through the specimen loaded on the transportation surface,
wherein the transportation unit includes a hole portion through which the transportation surface and the surface opposite the transportation surface communicate with each other, and is configured so that the specimen can be loaded on the hole portion.

2. The specimen inspection apparatus according to claim 1,
wherein the transportation surface includes a recess on which the specimen is loaded, and
the hole portion causes the recess and the surface opposite the transportation surface to communicate with each other.

3. The specimen inspection apparatus according to claim 1,
wherein a width of the hole portion is smaller than a width of the specimen.

4. The specimen inspection apparatus according to claim 1,
wherein the transportation unit is configured so that one specimen can be loaded on one hole portion.

5. The specimen inspection apparatus according to claim 1,
wherein the transportation unit is configured so that the plurality of specimens can be loaded on the hole portion.

6. The specimen inspection apparatus according to claim 1,
wherein the terahertz wave generation unit includes
an optical pulse generation unit which generates an optical pulse, and
a photoconductive antenna which is irradiated with the optical pulse generated by the optical pulse generation unit.

7. The specimen inspection apparatus according to claim 1, further comprising:
a gas ejection unit which ejects gas towards the specimen loaded on the transportation surface through the hole portion to separate the specimen from the transportation surface.

8. The specimen inspection apparatus according to claim 1,
wherein the hole portion is provided in a region in which the terahertz wave transmitting through the specimen of the transportation unit passes through, and
the terahertz wave detection unit detects the terahertz wave passing through the hole portion.

9. The specimen inspection apparatus according to claim 2,
wherein the hole portion is provided in a region in which the terahertz wave transmitting through the specimen of the transportation unit passes through, and
the terahertz wave detection unit detects the terahertz wave passing through the hole portion.

10. The specimen inspection apparatus according to claim 3,
wherein the hole portion is provided in a region in which the terahertz wave transmitting through the specimen of the transportation unit passes through, and
the terahertz wave detection unit detects the terahertz wave passing through the hole portion.

11. The specimen inspection apparatus according to claim 4,
wherein the hole portion is provided in a region in which the terahertz wave transmitting through the specimen of the transportation unit passes through, and
the terahertz wave detection unit detects the terahertz wave passing through the hole portion.

12. The specimen inspection apparatus according to claim 5,
wherein the hole portion is provided in a region in which the terahertz wave transmitting through the specimen of the transportation unit passes through, and
the terahertz wave detection unit detects the terahertz wave passing through the hole portion.

13. The specimen inspection apparatus according to claim 6,
wherein the hole portion is provided in a region in which the terahertz wave transmitting through the specimen of the transportation unit passes through, and
the terahertz wave detection unit detects the terahertz wave passing through the hole portion.

14. The specimen inspection apparatus according to claim 7,
wherein the hole portion is provided in a region in which the terahertz wave transmitting through the specimen of the transportation unit passes through, and
the terahertz wave detection unit detects the terahertz wave passing through the hole portion.
